(19) United States
(12) Patent Application Publication
(10) Pub. No.: US 2009/0309959 A1
(43) Pub. Date: Dec. 17, 2009

(54) STEREOSCOPIC IMAGE PROJECTOR AND ADAPTER FOR STEREOSCOPIC IMAGE PROJECTOR

(76) Inventors: Junichi IWAI, Kanagawa (JP); Keisuke Hisano, Kanagawa (JP); Seiji Oura, Kanagawa (JP)

Correspondence Address: FROMMER LAWRENCE & HAUG LLP, 745 FIFTH AVENUE, NEW YORK, NY, 10151, US

(21) Appl. No.: 12/485,437

(22) Filed: Jun. 16, 2009

(30) Foreign Application Priority Data
Jun. 17, 2008 (JP) P2008-157579

(51) Int. Cl. H04N 13/04; H04N 9/31

(52) U.S. Cl. 348/54; 348/E13.001; 348/744

(57) ABSTRACT

A stereoscopic image projector includes: an image generator configured to generate three left-eye wavelength-specific images and three right-eye wavelength-specific images having different wavelengths by modulating three light beams having the different wavelengths in spatial modulators; an image combiner configured to combine the three left-eye wavelength-specific images into a single left-eye combined image and the three right-eye wavelength-specific images into a single right-eye combined image; a relay lens configured to receive the left-eye and right-eye combined images and focus real images of the left-eye and right-eye combined images that are separated from each other; a light guide configured to separately guide the real images of the left-eye and right-eye combined images; a left-eye image projection lens and a right-eye image projection lens respectively configured to project the real images of the left-eye and right-eye combined images guided through the light guide on a screen so that left-eye and right-eye images are focused.

### BACKGROUND OF THE INVENTION

1. Field of the Invention

The present invention relates to a stereoscopic image projector and an adaptor for the stereoscopic image projector.

2. Description of the Related Art

A variety of stereoscopic image projectors for displaying a stereoscopic image by using a single projector to project a left-eye image and a right-eye image on a screen have been proposed (see Japanese Patent No. 3,531,348, JP-A-2001-305478, JP-A-2005-62607, and JP-A-2007-271828).

In these apparatus of related art, an image having exited through a projection lens in the projector is separated into the left-eye image and the right-eye image by using a separator including a mirror, a prism, or any other suitable optical component.

### SUMMARY OF THE INVENTION

However, in any of the apparatus of related art described above, in which the image having exited through the projection lens is separated by using the separator in principle, part of the light having exited through the projection lens may not be clearly separated into the left-eye image and the right-eye image by the separator.

As a result, part of the light that should form the left-eye image or the right-eye image is not projected in a correct position. The left-eye image and the right-eye image on the screen thus disadvantageously suffer from reduction in brightness and image quality.

In view of the above circumstances, it is desirable to provide a stereoscopic image projector that is advantageous in improving the brightness and image quality, and an adaptor for the stereoscopic image projector.

According to an embodiment of the invention, there is provided a stereoscopic image projector including an image generator configured to generate three left-eye wavelength-specific images and three right-eye wavelength-specific images having different wavelengths by modulating three light beams having the different wavelengths in spatial modulators, an image combiner configured to combine the three left-eye wavelength-specific images into a single left-eye combined image and the three right-eye wavelength-specific images into a single right-eye combined image, a relay lens configured to receive the left-eye combined image and the right-eye combined image and focus a real image of the left-eye combined image and a real image of the right-eye combined image that are separated from each other, a light guide configured to separately guide the real image of the left-eye combined image and the real image of the right-eye combined image, a left-eye image projection lens configured to project the real image of the left-eye combined image guided through the light guide on a screen so that a left-eye image is focused, and a right-eye image projection lens configured to project the real image of the right-eye combined image guided through the light guide on the screen so that a right-eye image is focused.

There is also provided an adaptor for a stereoscopic image projector, the adaptor including a relay lens configured to receive a left-eye combined image that is a combined single image formed of three left-eye wavelength-specific images having different wavelengths and a right-eye combined image that is a combined single image formed of three right-eye wavelength-specific images having different wavelengths through the entrance surface of the relay lens and output a focused real image of the left-eye combined image and a focused real image of the right-eye combined image that are separated from each other through the exit surface of the relay lens, a light guide configured to face the exit surface of the relay lens and separately guide the real image of the left-eye combined image and the real image of the right-eye combined image in the direction away from the exit surface, and an attachment member configured to hold the relay lens and the light guide.

According to the embodiment of the invention, using the relay lens allows the real image of the left-eye combined image and the real image of the right-eye combined image to be separated and then guided through the light guide. The configuration can therefore prevent reduction in brightness of the left-eye and right-eye images and is advantageous in improving the image quality.

### BRIEF DESCRIPTION OF THE DRAWINGS

FIG. 1 is a plan view showing the configuration of a stereoscopic image projector 10 of an embodiment;

FIGS. 2A to 2C explain a display screen 1402 of each of reflective liquid crystal panels 14R, 14G, and 14B;

FIG. 3 explains the operation of the stereoscopic image projector 10 of the present embodiment;

FIG. 4 explains the operation of the stereoscopic image projector 10 of the present embodiment; and

FIGS. 5A, 5B, and 5C explain the operation of a stereoscopic image projector 2 of a comparative example.

### DESCRIPTION OF THE PREFERRED EMBODIMENTS

An embodiment of the invention will be described below with reference to the drawings.

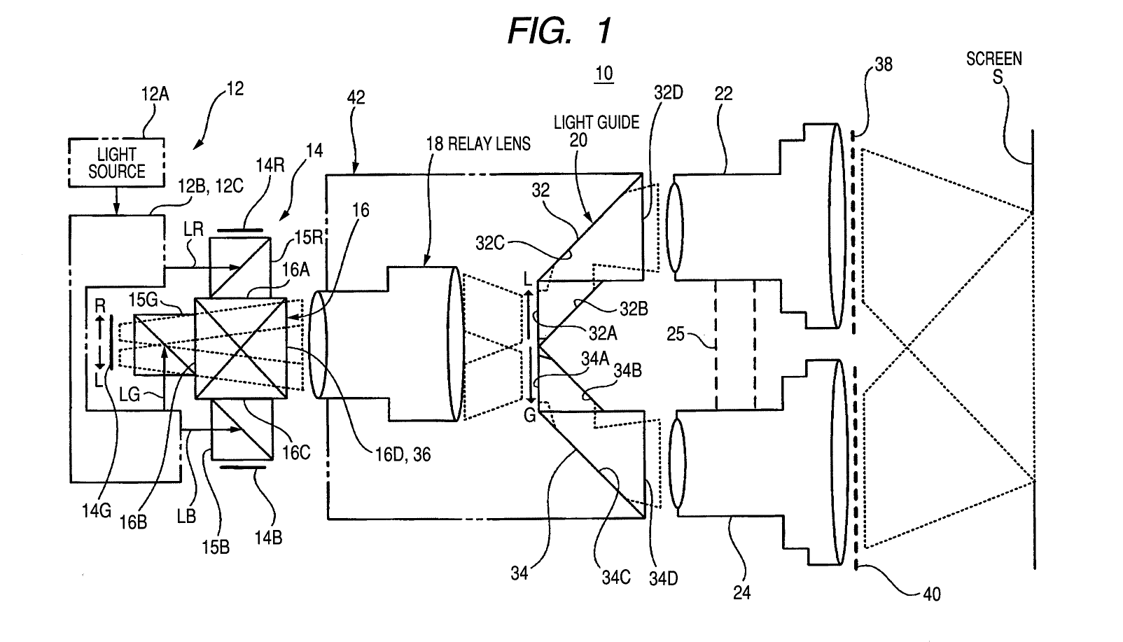

FIG. 1 is a plan view showing the configuration of a stereoscopic image projector 10 of the present embodiment.

The stereoscopic image projector 10 includes an illuminator 12, an image generator 14, an image combiner 16, a relay lens 18, a light guide 20, a left-eye image projection lens 22, a right-eye image projection lens 24, and first to third polarization control filters 36, 38, 40.

The broken lines in FIG. 1 represent light rays.

### (Illuminator 12)

The illuminator 12 guides three light beams having different wavelengths to the image generator 14.

In the present embodiment, the illuminator 12 includes a light source 12A, an illumination optical unit 12B, and a separator 12C.

The light source 12A includes a lamp that emits white light.

Examples of the lamp include a high-pressure mercury lamp that emits white light and a variety of other known lamps.

The illumination optical unit 12B collimates the white light emitted from the lamp, aligns the polarization states of the white light into a predetermined one, and guides the collimated, polarized light to the separator 12C.

The illumination optical unit 12B includes a UV-IR cut filter, a fly-eye lens, a PS converter, and a condenser lens that are disposed downstream of the light source 12A. The white light from the light source 12A passes through the above components, is converted into predetermined polarized, collimated light, and is incident on the separator 12C.

The separator 12C separates the light (white light) guided through the illumination optical unit 12B into three light beams having different wavelengths, that is, a red (R) light beam LR, a green (G) light beam LG, and a blue (B) light beam LB, and guides them to the image generator 14.

The separator 12C includes, for example, two dichroic mirrors, a plurality of reflection mirrors, and a plurality of lenses. The separator 12C can have any of a variety of known configurations of related art.

### (Image Generator 14)

In the image generator 14, spatial modulators modulate the three light beams LR, LG, and LB having different wavelengths to generate three left-eye wavelength-specific images and three right-eye wavelength-specific images having different wavelengths.

In the present embodiment, the image generator 14 includes first to third reflective liquid crystal panels 14R, 14G, 14B, which serve as first to third spatial modulators, and first to third polarizing beam splitters 15R, 15G, 15B.

The first to third reflective liquid crystal panels 14R, 14G, 14B, which display respective color (red, green, and blue) image information, receive applied color image signals according to the incident light, modulate the incident light by rotating the polarization direction thereof in accordance with the image signals, and output the modulated light beams.

Each of the first to third spatial modulators is not limited to a reflective liquid crystal panel, but can be a transmissive liquid crystal panel, a DMD (Digital Micro mirror Device) using a large number of tiny reflection mirrors, or any of a variety of other known spatial modulators.

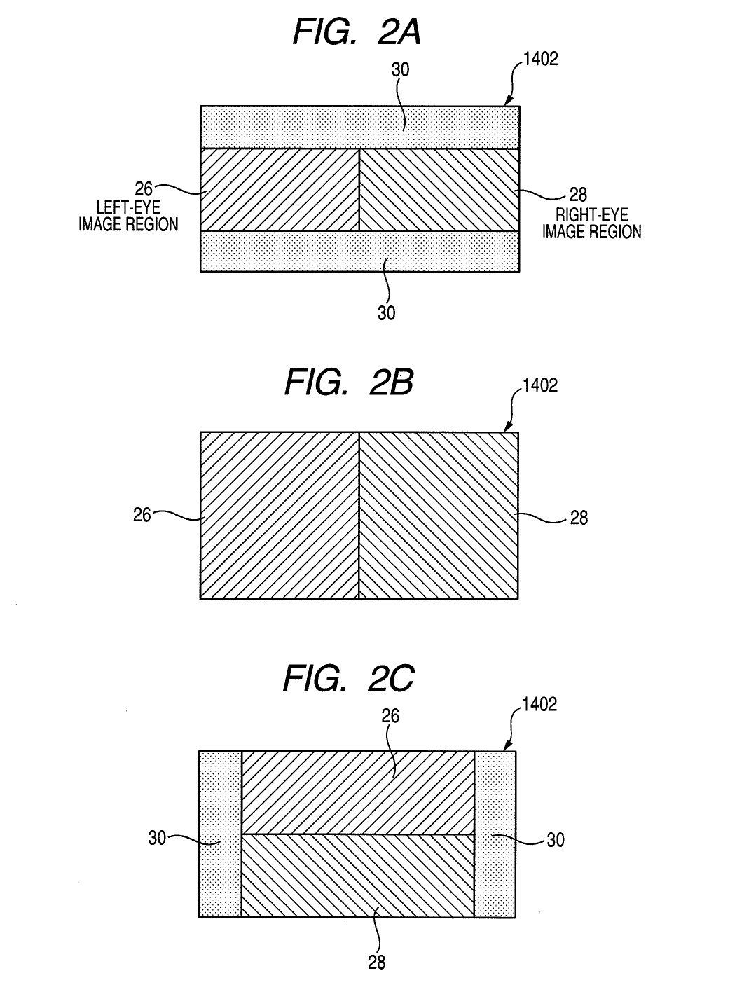

FIGS. 2A to 2C explain a display screen 1402 of each of the reflective liquid crystal panels 14R, 14G, and 14B.

Each of the reflective liquid crystal panels 14R, 14G, and 14B has the rectangular display screen 1402 of the same shape and size. In the present embodiment, the display screen 1402 has a display region including 4096 horizontal pixels by 2160 vertical pixels.

As shown in FIG. 2A, a vertically central portion of the display screen 1402 is divided at the horizontal center into left and right portions, a left-eye image region 26 and a right-eye image region 28.

In this case, the display regions 26 and 28 are shaped into horizontally elongated rectangles of the same shape and size, and the remaining region other than the left-eye image region 26 and the right-eye image region 28 forms non-display regions 30 in which no image is displayed.

Each of the reflective liquid crystal panels 14R, 14G, and 14B, when the image signals are applied thereto, displays a left-eye image in the left-eye image region 26 and a right-eye image in the right-eye image region 28.

Alternatively, as shown in FIG. 2B, the display screen 1402 is divided at the horizontal center into left and right portions, a left-eye image region 26 and a right-eye image region 28.

In this case, the image regions 26 and 28 are shaped into substantially square forms of the same shape and size, and no non-display area 30 is formed.

Alternatively, as shown in FIG. 2C, a horizontally central portion of the display screen 1402 may be divided at the vertical center into upper and lower portions, a left-eye image region 26 and a right-eye image region 28. In this case, the image regions 26 and 28 are shaped into horizontally elongated rectangles of the same shape and size, and the remaining region other than the display regions 26 and 28 forms non-display regions 30 in which no image is displayed.

The first polarizing beam splitter 15R reflects the light beam LR to let it be incident on the first reflective liquid crystal panel 14R, and transmits the light beam LR spatially modulated by the first reflective liquid crystal panel 14R to let the light beam LR be incident on the image combiner 16.

That is, the first polarizing beam splitter 15R allows a left-eye wavelength-specific image and a right-eye wavelength-specific image formed of the red light beam LR to be incident on the image combiner 16.

The second polarizing beam splitter 15G reflects the light beam LG to let it be incident on the second reflective liquid crystal panel 14G, and transmits the light beam LG spatially modulated by the second reflective liquid crystal panel 14G to let the light beam LG be incident on the image combiner 16.

That is, the second polarizing beam splitter 15G allows a left-eye wavelength-specific image and a right-eye wavelength-specific image formed of the green light beam LG to be incident on the image combiner 16.

The third polarizing beam splitter 15B reflects the light beam LB to let it be incident on the third reflective liquid crystal panel 14B, and transmits the light beam LB spatially modulated by the third reflective liquid crystal panel 14B to let the light beam LB be incident on the image combiner 16.

That is, the third polarizing beam splitter 15B allows a left-eye wavelength-specific image and a right-eye wavelength-specific image formed of the blue light beams LB to be incident on the image combiner 16.

### (Image Combiner 16)

The image combiner 16 combines the three left-eye wavelength-specific images into a single left-eye combined image and the three right-eye wavelength-specific images into a single right-eye combined image.

That is, the image combiner 16 combines the color light beams that have been modulated by the first to third reflective liquid crystal panels 14R, 14G, 14B and have passed through the first to third polarizing beam splitters 15R, 15G, 15B.

In the present embodiment, the image combiner 16 is a light combining prism.

The image combiner 16 has first to third entrance surfaces 16A, 16B, 16C on which the color light beams having passed through the first to third polarizing beam splitters 15R, 15G, 15B are incident, and an exit surface 16D through which a combined image exits.

The image combiner 16 can be any of a variety of known suitable optical members instead of a light combining prism.

### (Relay Lens 18)

The relay lens 18 receives the left-eye combined image and the right-eye combined image having exited through the image combiner 16 and focuses a real image of the left-eye combined image and a real image of the right-eye combined image that are separated from each other.

In other words, the relay lens 18 receives the left-eye combined image, which is the combined single image formed of the left-eye wavelength-specific images, and the right-eye combined image, which is the combined single image formed of the right-eye wavelength-specific images, incident on the entrance surface of the relay lens 18, and outputs a focused real image of the left-eye combined image and a focused real image of the right-eye combined image separated from each other through the exit surface of the relay lens 18.

In the present embodiment, the real image of the left-eye combined image and the real image of the right-eye combined image having exited through the relay lens 18 are twice as large as the left-eye combined image and the right-eye combined image having exited through the image combiner 16. The magnification of the relay lens 18 may alternatively be unity or smaller.

### (Light Guide 20)

The light guide 20 separately guides the focused real image of the left-eye combined image and the focused real image of the right-eye combined image having exited through the relay lens 18.

In the present embodiment, the light guide 20 includes first and second prisms 32, 34.

The first prism 32 has an entrance surface 32A on which the real image of the left-eye combined image is incident, a first reflection surface 32B that reflects and deflects the real image of the left-eye combined image incident through the entrance surface 32A by approximately 90 degrees with respect to the optical axis of the relay lens 18, a second reflection surface 32C that deflects the real image of the left-eye combined image reflected off the first reflection surface 32B by approximately 90 degrees toward the direction parallel to the optical axis of the relay lens 18, and an exit surface 32D through which the real image of the left-eye combined image reflected off the second reflection surface 32C exits in the direction parallel to the optical axis of the relay lens 18.

The second prism 34 has an entrance surface 34A on which the real image of the right-eye combined image is incident, a first reflection surface 34B that reflects and deflects the real image of the right-eye combined image incident through the entrance surface 34A by approximately 90 degrees with respect to the optical axis of the relay lens 18, a second reflection surface 34C that deflects the real image of the right-eye combined image reflected off the first reflection surface 34B by approximately 90 degrees toward the direction parallel to the optical axis of the relay lens 18, and an exit surface 34D through which the real image of the right-eye combined image reflected off the second reflection surface 34C exits in the direction parallel to the optical axis of the relay lens 18.

In other words, the light guide 20 faces the exit surface of the relay lens 18 and separately guides the real image of the left-eye combined image and the real image of the right-eye combined image in the direction away from the exit surface of the relay lens 18.

The optical path formed in the first prism 32 and the optical path formed in the second prism 34 extend in the same plane and are spaced apart from each other in the direction perpendicular to the optical axis of the relay lens 18. The exit surface 32D of the first prism 32 and the exit surface 34D of the second prism 34 are therefore spaced apart from each other in the direction perpendicular to the optical axis of the relay lens 18.

In other words, the light guide 20 is configured to guide the focused real image of the left-eye combined image and the focused real image of the right-eye combined image having exited through the relay lens 18 to locations spaced apart from each other in the direction perpendicular to the optical axis of the relay lens 18.

In the present embodiment, the relay lens 18 and the light guide 20 are held by an attachment member (not shown) and form an adaptor 42 for a stereoscopic image projector.

The adaptor 42 for a stereoscopic image projector is removably attached to the stereoscopic image projector 10.

### (Left-Eye Image Projection Lens 22, Right-Eye Image Projection Lens 24)

The left-eye image projection lens 22 projects the real image of the left-eye combined image guided through the light guide 20 on a screen S so that a left-eye image is focused.

The right-eye image projection lens 24 projects the real image of the right-eye combined image guided through the light guide 20 on the screen S so that a right-eye image is focused.

A lens shift mechanism 25 is further provided. The lens shift mechanism 25 adjusts the distance between the left-eye image projection lens 22 and the right-eye image projection lens 24 in the direction perpendicular to the optical axes of the left-eye image projection lens 22 and the right-eye image projection lens 24 while keeping the optical axes parallel to each other.

Using the lens shift mechanism 25 to adjust the distance between the left-eye image projection lens 22 and the right-eye image projection lens 24 allows the left-eye image and the right-eye image projected on the screen S to be superimposed irrespective of the distance from the left-eye image projection lens 22 and the right-eye image projection lens 24 to the screen S.

### (First Polarization Control Filter 36)

The first polarization control filter 36 is provided on the exit surface 16D of the image combiner 16, and converts the polarization of the light that forms the combined images having exited through the exit surface 16D from circular polarization to linear polarization.

An example of the first polarization control filter 36 may be a quarter-wave plate.

That is, the light having exited through the exit surface 16D of the image combiner 16 is circularly polarized.

When circularly polarized light passes through the first and second prisms 32, 34, which form the light guide 20, the state of the circularly polarized light is disturbed because each of the first and second prisms 32, 34 serve as a Fresnel rhomb wave plate.

When the thus disturbed circularly polarized light is converted into linearly polarized light by the polarization control filters provided downstream of the light guide 20, intended linearly polarized light may not be obtained, which may disadvantageously lower brightness of the images focused on the screen S.

To address the problem, in the present embodiment, the first polarization control filter 36 is provided to output linearly polarized light, which is then incident on the first and second prisms 32, 34, which form the light guide 20. The above inconvenience is thus eliminated.

It is noted that the first polarization control filter 36 may be disposed in any position as long as it is located between the exit surface 16D of the image combiner 16 and the entrance surfaces 32A, 34A of the light guide 20.

### (Second Polarization Control Filter 38, Third Polarization Control Filter 40)

The second polarization control filter 38 is disposed downstream of the exit surface of the left-eye image projection lens 22, and converts the linearly polarized light that forms the real image of the left-eye combined image having exited through the left-eye image projection lens 22 into first linearly polarized light (polarized in one of the vertical and horizontal direction, for example).

The third polarization control filter 40 is disposed downstream of the exit surface of the right-eye image projection lens 24, and converts the linearly polarized light that forms the real image of the right-eye combined image having exited through the right-eye image projection lens 24 into second linearly polarized light (polarized in the other one of the vertical and horizontal direction, for example).

The second and third polarization control filters 38, 40 may be disposed upstream of the entrance surfaces of the projection lenses 22 and 24, respectively.

The left-eye image and the right-eye image superimposed and displayed on the screen S are visually recognized as a stereoscopic image when viewed through stereoscopic vision glasses.

The stereoscopic vision glasses include a left-eye filter and a right-eye filter.

The left-eye filter transmits the light that forms the left-eye image focused on the screen S, and includes a polarization control filter that transmits the first linearly polarized light in the present embodiment.

The right-eye filter transmits the light that forms the right-eye image focused on the screen S, and includes a polarization control filter that transmits the second linearly polarized light in the present embodiment.

The second and third polarization control filters 38, 40 may be replaced with wavelength selection filters having different transmission characteristics so that the wavelength distribution of the light that forms the left-eye image and the wavelength distribution of the light that forms the right-eye image, which are superimposed and displayed on the screen S, differ from each other.

In this case, a wavelength selection filter that transmits the light that forms the left-eye image may be used as the left-eye filter of the stereoscopic vision glasses, and a wavelength selection filter that transmits the light that forms the right-eye image may be used as the right-eye filter of the stereoscopic vision glasses.

As described above, according to the present embodiment, using the relay lens 18 allows the real image of the left-eye combined image and the real image of the right-eye combined image to be separated and then guided through the light guide 20 to the left and right projection lenses 22, 24. The configuration can therefore prevent reduction in brightness of the left-eye and right-eye images and is advantageous in improving the image quality.

The present embodiment will be described in detail in comparison with a comparative example.

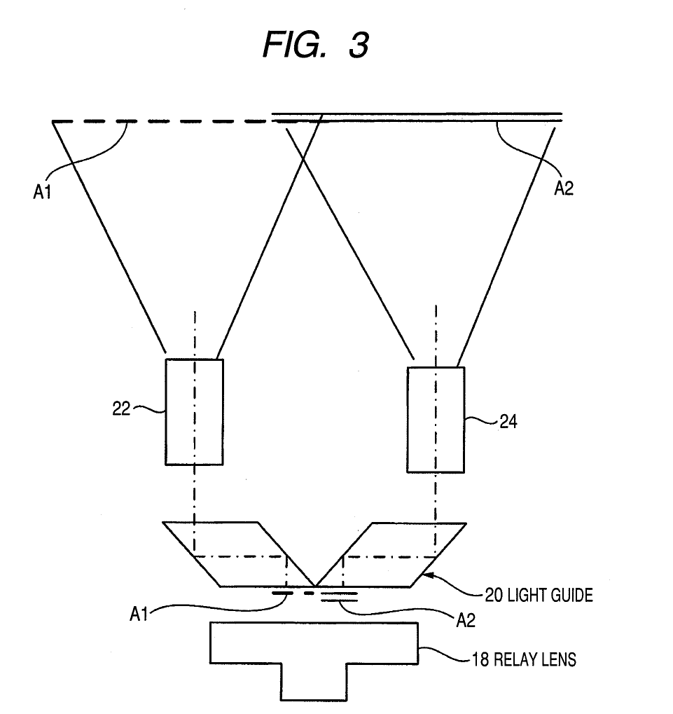

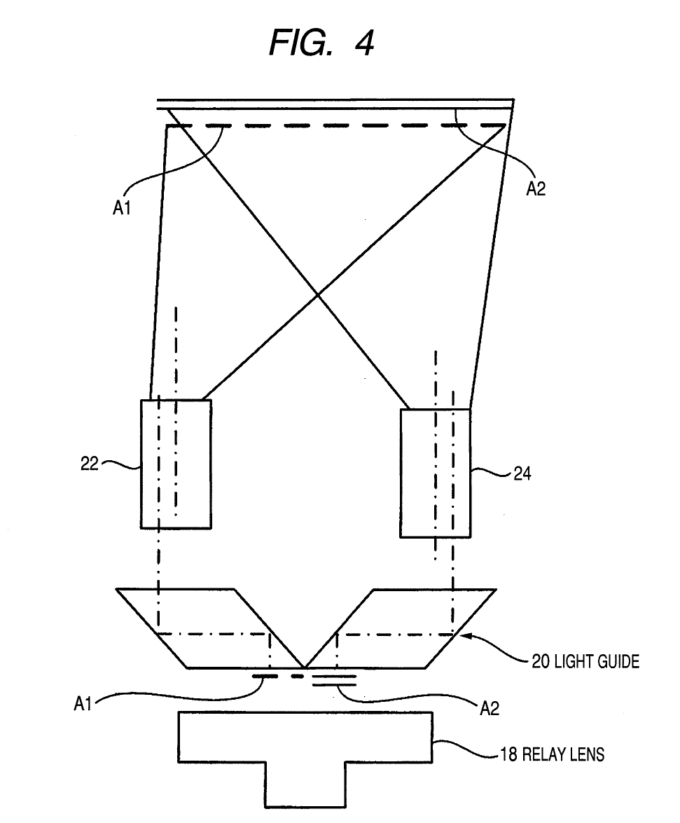

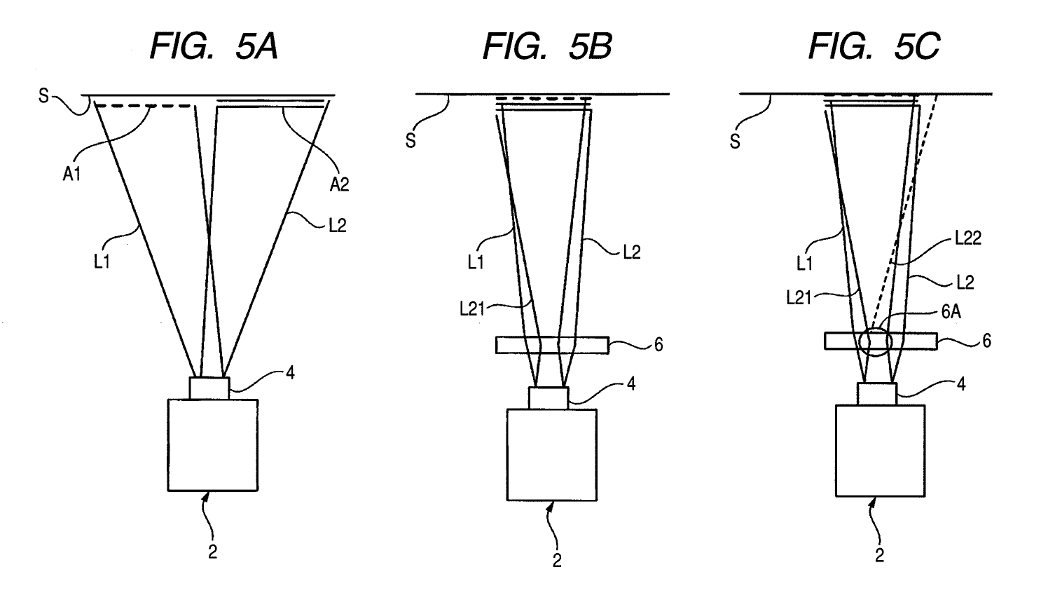

FIGS. 3 and 4 explain the operation of the stereoscopic image projector 10 of the present embodiment, and FIGS. 5A, 5B, and 5C explain the operation of a stereoscopic image projector 2 of the comparative example.

As shown in FIG. 5A, the stereoscopic image projector 2 including the illuminator 12, the image generator 14, and the image combiner 16 of the present embodiment is configured to output a left-eye image A1 and a right-eye image A2 through a single projection lens 4.

As shown in FIG. 5B, a separating/combining mechanism 6 is provided. The separating/combining mechanism 6 separates the left-eye image and the right-eye image having exited through the projection lens 4 and superimposes them on the screen S.

The separating/combining mechanism 6 is formed by combining a plurality of prisms or combining a plurality of mirrors.

As shown in FIG. 5C, in the comparative example, part of light L1 that forms the left-eye image A1 and part of light L2 that forms the right-eye image A2 are superimposed in an image separator 6A of the separating/combining mechanism 6. The superimposed light may not be used in the image separation operation.

For example, among the light rays of the light L2 that forms the right-eye image A2, a light ray L21 that should form the left end of the right-eye image A2 is superimposed on the light L1 that forms the left-eye image. The separator 6A of the separating/combining mechanism 6 therefore handles the light ray L21 and the light L1 that forms the left-eye image A1 in the same manner. As a result, the light ray L21 is disadvantageously guided to a point outside the right end of the right-eye image A2, as indicated by a broken line L22.

Accordingly, the light ray L21 that should originally be guided to the left end of the right-eye image A2 is lost, resulting in reduction in brightness of the left end portion of the right-eye image A2 and degradation in image quality because part of information that forms the image is lost.

In contrast, in the present embodiment, using the relay lens 18 allows the real image A1 of the left-eye combined image and the real image A2 of the right-eye combined image to be separated and then guided through the light guide 20 to the left and right projection lenses 22, 24, as shown in FIGS. 3 and 4. As a result, none of the light that forms the images will be lost. The configuration can therefore not only prevent reduction in brightness of the left-eye image A1 and the right-eye image A2 focused on the screen S, but also is advantageous in ensuring the image quality.

In particular, in the present embodiment, the lens shift mechanism 25 (FIG. 1) is used to adjust the distance between the left-eye image projection lens 22 and the right-eye image projection lens 24 in the direction perpendicular to the optical axes of the left-eye image projection lens 22 and the right-eye image projection lens 24 while keeping the optical axes parallel to each other, as shown in FIG. 4.

Therefore, since the angular relationship of the optical axes of the left-eye image projection lens 22 and the right-eye image projection lens 24 with the screen S does not change, the left-eye image A1 and the right-eye image A2 focused on the screen S do not suffer from trapezoidal distortion, and hence the left-eye image A1 and the right-eye image A2 can be accurately superimposed on each other, which is advantageous in providing a stereoscopic image with good image quality.

In the present embodiment, since the first and second prisms 32, 34 are used as the light guide 20, there will be, in an exact sense, a linearly extending small gap formed at the boundary between the entrance surface 32A of the first prism 32 and the entrance surface 34A of the second prism 34.

The light incident on the portion that corresponds to the gap may not be used to form an image.

It is therefore advantageous in preventing reduction in image quality not to form the image of the portion that corresponds to the gap in each of the first to third spatial modulators, that is, not to use the portion that corresponds to the gap in each of the spatial modulators.

Each of the first and second prisms 32, 34 as the light guide 20 may, of course, be replaced with combined mirrors.

Using combined mirrors, however, results in providing a first entrance mirror on which the real image of the left-eye combined image having exited through the relay lens 18 is incident and a second entrance mirror on which the real image of the right-eye combined image is incident.

Since each of the mirrors needs a certain thickness, the gap formed between the first and second entrance mirrors is larger than the gap formed when the first and second prisms 32, 34 are used, and hence the area of the unusable region in each of the first to third spatial modulators increases.

Using the first and second prisms 32, 34 as the light guide 20 is therefore more advantageous in improving the image quality.

The present application contains subject matter related to that disclosed in Japanese Priority Patent Application JP 2008-157579 filed in the Japan Patent Office on Jun. 17, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A stereoscopic image projector comprising:
an image generator configured to generate three left-eye wavelength-specific images and three right-eye wavelength-specific images having different wavelengths by modulating three light beams having the different wavelengths in spatial modulators;
an image combiner configured to combine the three left-eye wavelength-specific images into a single left-eye combined image and the three right-eye wavelength-specific images into a single right-eye combined image;
a relay lens configured to receive the left-eye combined image and the right-eye combined image and focus a real image of the left-eye combined image and a real image of the right-eye combined image that are separated from each other;
a light guide configured to separately guide the real image of the left-eye combined image and the real image of the right-eye combined image;
a left-eye image projection lens configured to project the real image of the left-eye combined image guided through the light guide on a screen so that a left-eye image is focused; and
a right-eye image projection lens configured to project the real image of the right-eye combined image guided through the light guide on the screen so that a right-eye image is focused.

2. The stereoscopic image projector according to claim 1,
wherein the light guide includes first and second prisms,
the first prism has an entrance surface on which the real image of the left-eye combined image is incident, a reflection surface that reflects the real image of the left-eye combined image incident through the entrance surface, and an exit surface through which the real image of the left-eye combined image reflected off the reflection surface exits, and
the second prism has an entrance surface on which the real image of the right-eye combined image is incident, a reflection surface that reflects the real image of the right-eye combined image incident through the entrance surface, and an exit surface through which the real image of the right-eye combined image reflected off the reflection surface exits.

3. The stereoscopic image projector according to claim 1,
wherein the left-eye image projection lens and the right-eye image projection lens are configured to superimpose the left-eye image and the right-eye image on each other.

4. The stereoscopic image projector according to claim 1, further comprising a lens shift mechanism configured to adjust the distance between the left-eye image projection lens and the right-eye image projection lens in the direction perpendicular to the optical axes of the left-eye image projection lens and the right-eye image projection lens while keeping the optical axes parallel to each other.

5. The stereoscopic image projector according to claim 1,
wherein the number of the spatial modulators are three, the spatial modulators corresponding to the three light beams, and
each of the spatial modulators has a left-eye image region in which the left-eye image is generated and a right-eye image region in which the right-eye image is generated.

6. The stereoscopic image projector according to claim 1, further comprising a polarization control filter provided upstream of the entrance surface or downstream of the exit surface of each of the left-eye image projection lens and the right-eye image projection lens, the polarization control filters converting the polarization state of the light that forms the real image of the left-eye combined image to be projected on the screen and the polarization state of the light that forms the real image of the right-eye combined image to be projected on the screen in such a way that the two polarization states differ from each other.

7. The stereoscopic image projector according to claim 1, further comprising a wavelength selection filter provided upstream of the entrance surface or downstream of the exit surface of each of the left-eye image projection lens and the right-eye image projection lens, the wavelength selection filters converting the wavelength distribution of the light that forms the real image of the left-eye combined image to be projected on the screen and the wavelength distribution of the light that forms the real image of the right-eye combined image to be projected on the screen in such a way that the two wavelength distributions differ from each other.

8. The stereoscopic image projector according to claim 1,
wherein the light that forms the left-eye wavelength-specific images and the right-eye wavelength-specific images generated in the image generator is circularly polarized,
the light guide includes a prism,
the prism has an entrance surface on which the real image of the left-eye combined image and the real image of the right-eye combined image are incident, a reflection surface that reflects the real images incident through the entrance surface, and an exit surface through which the real images reflected off the reflection surface exit, and
a polarization control filter is provided between the image combiner and the entrance surface of the light guide, the polarization control filter converting the polarization state of the light that forms the real image of the left-eye combined image to be projected on the screen and the polarization state of the light that forms the real image of the right-eye combined image to be projected on the screen from circularly polarized light into linearly polarized light.

9. An adaptor for a stereoscopic image projector, the adaptor comprising:
a relay lens configured to receive a left-eye combined image that is a combined single image formed of three left-eye wavelength-specific images having different wavelengths and a right-eye combined image that is a combined single image formed of three right-eye wavelength-specific images having different wavelengths through the entrance surface of the relay lens and output a focused real image of the left-eye combined image and a focused real image of the right-eye combined image that are separated from each other through the exit surface of the relay lens;
a light guide configured to face the exit surface of the relay lens and separately guide the real image of the left-eye combined image and the real image of the right-eye combined image in the direction away from the exit surface; and
an attachment member configured to hold the relay lens and the light guide.
